(19) United States
(12) Patent Application Publication
(10) Pub. No.: US 2021/0127071 A1
(43) Pub. Date: Apr. 29, 2021

(54) METHOD, SYSTEM AND COMPUTER PROGRAM PRODUCT FOR OBJECT-INITIATED REDACTION OF SURVEILLANCE VIDEO

(71) Applicant: MOTOROLA SOLUTIONS, INC., Chicago, IL (US)

(72) Inventors: Sven Tommi Rebien, Victoria (CA); Pietro Russo, Melrose, MA (US)

(73) Assignee: MOTOROLA SOLUTIONS, INC., Chicago, IL (US)

(21) Appl. No.: 16/666,642

(22) Filed: Oct. 29, 2019

(51) Int. Cl. H04N 5/262; G06K 9/00

(52) U.S. Cl. CPC H04N 5/262; G06K 9/00718; G06K 2009/00738; G06K 9/00355; G06K 9/00771

(57) ABSTRACT

A method, system and computer program product for object-initiated redaction of surveillance video is disclosed. Video analytics is used to detect and recognize a predefined gesture being made by an object appearing in analyzable video. In response to a determination that the predefined gesture has been made, at least some appearance instances of the object are redacted from videos captured by different cameras.

### BACKGROUND

In the context of video surveillance, masking can be used to obscure certain video image details (for example, portions of video image frames in a video image stream). One or more objects can form a part of the portions of a video to be obscured. For instance, security footage may include private information (such as, for example, license plates and faces) that need to be obscured to allow publishing or dissemination in a manner that would otherwise violate privacy. When footage is used in a public manner, one has to consider whether there is some legal or other requirement(s) to obscure people's faces, address markers, or other objects, for privacy concerns.

### BRIEF DESCRIPTION OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 shows a block diagram of an example surveillance system, including a client-side video review application, within which methods in accordance with example embodiments can be carried out.

FIG. 2 shows a user interface page, for concurrently viewing a plurality of videos, in accordance with an example embodiment implemented using the client-side video review application of FIG. 1.

FIG. 3 shows a subregion of the user interface page of FIG. 2 in a pre-redaction state.

FIG. 4 is a flow chart illustrating a method for object-initiated redaction of surveillance video in accordance with an example embodiment.

FIG. 5 shows the same subregion of the user interface page as shown in FIG. 3, but in a post-redaction state.

FIG. 6 shows a similar subregion of a user interface page as shown in FIG. 5, but where segmentation mask redaction, instead of rectangular area redaction, has been carried out.

FIG. 7 shows a similar subregion of a user interface page as shown in FIG. 5, but where cartoon redaction, instead of rectangular area redaction, has been carried out.

FIG. 8 shows a user interface page, for carrying out an appearance search, in accordance with another example embodiment implemented using the client-side video review application of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF EXAMPLE EMBODIMENTS

According to one example embodiment, there is provided a method that includes using video analytics to detect and recognize a predefined gesture being made by an object appearing in analyzable video. The method also includes, in response to a determination that the predefined gesture has been made, redacting at least some appearance instances of the object present within first video captured by a first video camera and second video captured by a second camera.

According to another example embodiment, there is provided an apparatus that includes a server configured to use video analytics to detect and recognize a predefined gesture being made by an object appearing in analyzable video. The server is also configured to redact, in response to a determination that the predefined gesture has been made, at least some appearance instances of the object present within first video captured by a first video camera and second video captured by a second camera.

According to yet another example embodiment, there is provided a tangible, non-transitory, computer-readable storage medium having instructions encoded therein. The instructions, when executed by at least one processor, causes a carrying out of a method that includes using video analytics to detect and recognize a predefined gesture being made by an object appearing in analyzable video. The method also includes, in response to a determination that the predefined gesture has been made, redacting at least some appearance instances of the object present within first video captured by a first video camera and second video captured by a second camera.

According to yet another example embodiment, there is provided a method that includes using video analytics to detect and recognize a predefined gesture being made by an object appearing in analyzable video. The method also includes, in response to a determination that the predefined gesture has been made, partly or fully cartoonizing at least some appearance instances of the object present within first video captured by a first video camera and second video captured by a second camera.

Each of the above-mentioned embodiments will be discussed in more detail below, starting with example system and device architectures of the system in which the embodiments may be practiced, followed by an illustration of processing blocks for achieving an improved technical method, device, and system for object-initiated redaction of surveillance video. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Various example embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is contemplated that any part of any aspect or embodiment discussed in this specification can be implemented or combined with any part of any other aspect or embodiment discussed in this specification.

The term “object” as used herein means the whole or a distinguishing part of an intelligent object capable of movement such as, for example, humans (full body), humans (face only), humanoid robots, etc.

The term “predefined” as used herein means defined prior to normal operation of the application or software including, for example, during installation or setup (by a computer operator) or by the software developer before parts or all of the application or software are obtained by the customer.

The term “gesture” as used herein means either one or a combination of: i) an identifiable movement of at least one part of an object, and with respect to which video analytics can distinguish from other movements of part(s) of that object which are not the identifiable movement; and ii) an identifiable stationary arrangement of a plurality of parts of an object, and with respect to which video analytics can distinguish from other stationary arrangements of parts of that object which are not the identifiable stationary arrangement.

Further advantages and features consistent with this disclosure will be set forth in the following detailed description, with reference to the figures.

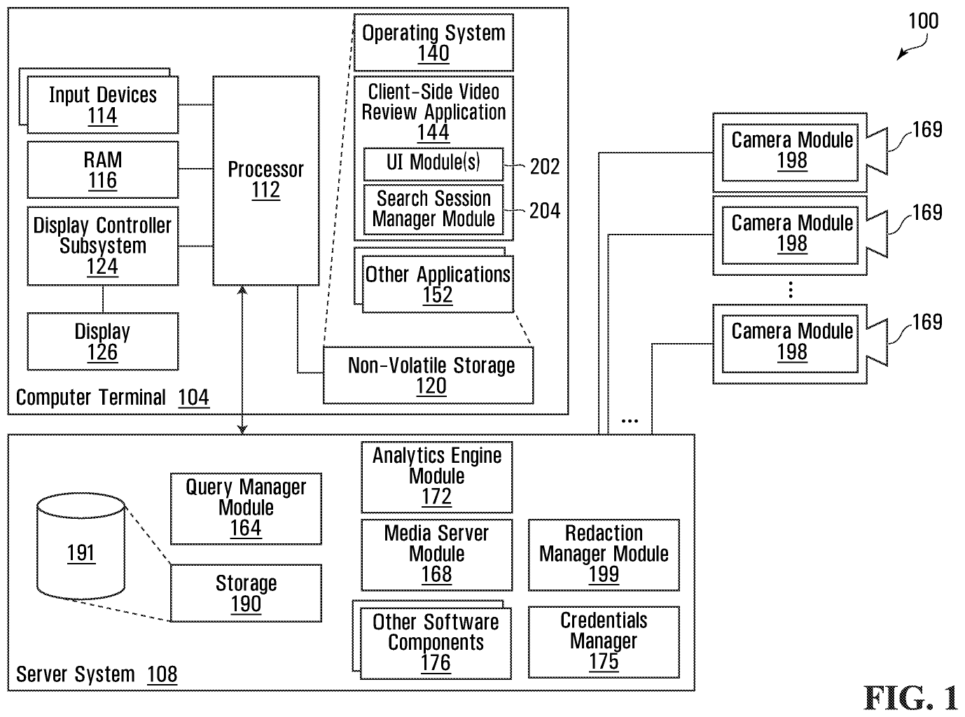

Reference is now made to FIG. 1 which shows a block diagram of an example surveillance system 100 within which methods in accordance with example embodiments can be carried out. Included within the illustrated surveillance system 100 are one or more computer terminals 104 and a server system 108. In some example embodiments, the computer terminal 104 is a personal computer system; however in other example embodiments the computer terminal 104 is a selected one or more of the following: a handheld device such as, for example, a tablet, a phablet, a smart phone or a personal digital assistant (PDA); a laptop computer; a smart television; and other suitable devices. With respect to the server system 108, this could comprise a single physical machine or multiple physical machines. It will be understood that the server system 108 need not be contained within a single chassis, nor necessarily will there be a single location for the server system 108. As will be appreciated by those skilled in the art, at least some of the functionality of the server system 108 can be implemented within the computer terminal 104 rather than within the server system 108.

The computer terminal 104 communicates with the server system 108 through one or more networks. These networks can include the Internet, or one or more other public/private networks coupled together by network switches or other communication elements. The network(s) could be of the form of, for example, client-server networks, peer-to-peer networks, etc. Data connections between the computer terminal 104 and the server system 108 can be any number of known arrangements for accessing a data communications network, such as, for example, dial-up Serial Line Interface Protocol/Point-to-Point Protocol (SLIP/PPP), Integrated Services Digital Network (ISDN), dedicated lease line service, broadband (e.g. cable) access, Digital Subscriber Line (DSL), Asynchronous Transfer Mode (ATM), Frame Relay, or other known access techniques (for example, radio frequency (RF) links). In at least one example embodiment, the computer terminal 104 and the server system 108 are within the same Local Area Network (LAN).

The computer terminal 104 includes at least one processor 112 that controls the overall operation of the computer terminal. The processor 112 interacts with various subsystems such as, for example, input devices 114 (such as a selected one or more of a keyboard, mouse, touch pad, roller ball and voice control means, for example), random access memory (RAM) 116, non-volatile storage 120, display controller subsystem 124 and other subsystems [not shown]. The display controller subsystem 124 interacts with display 126 and it renders graphics and/or text upon the display 126.

Still with reference to the computer terminal 104 of the surveillance system 100, operating system 140 and various software applications used by the processor 112 are stored in the non-volatile storage 120. The non-volatile storage 120 is, for example, one or more hard disks, solid state drives, or some other suitable form of computer readable medium that retains recorded information after the computer terminal 104 is turned off. Regarding the operating system 140, this includes software that manages computer hardware and software resources of the computer terminal 104 and provides common services for computer programs. Also, those skilled in the art will appreciate that the operating system 140, client-side video review application 144, and other applications 152, or parts thereof, may be temporarily loaded into a volatile store such as the RAM 116. The processor 112, in addition to its operating system functions, can enable execution of the various software applications on the computer terminal 104.

Still with reference to FIG. 1, the video review application 144 can be run on the computer terminal 104 and includes one or more User Interface (UI) module(s) 202 for cooperation with a search session manager module 204 in order to enable a computer terminal user to carry out actions related to providing input such as, for example, input to facilitate identifying same individuals or objects appearing in a plurality of different video recordings and/or live video. In such circumstances, the user of the computer terminal 104 is provided with a user interface generated on the display 126 through which the user inputs and receives information in relation the video recordings and/or live video.

The video review application 144 also includes the search session manager module 204 mentioned above. The search session manager module 204 provides a communications interface between the search UI module 202 and a query manager module 164 of the server system 108. In at least some examples, the search session manager module 204 communicates with the query manager module 164 through the use of Remote Procedure Calls (RPCs). The query manager module 164 receives and processes queries originating from the computer terminal 104, which may facilitate retrieval and delivery of specifically defined video data and metadata in support of client-side video review, export, redaction, etc.

Still with reference to FIG. 1, the server system 108 includes several software components (besides the query manager module 164 already described) for carrying out other functions of the server system 108. For example, the server system 108 includes a media server module 168 (FIG. 1). The media server module 168 handles client requests related to storage and retrieval of surveillance video taken by video cameras 169 in the surveillance system 100. The server system 108 also includes an analytics engine module 172. The analytics engine module 172 can, in some examples, be any suitable one of known commercially available software to carry out video analytics within the surveillance system 100 including, for example, carrying out mathematical calculations (and other operations) to attempt computerized matching of same individuals or objects as between different portions of surveillance video. For example, the analytics engine module 172 can, in one specific example, be a software component of the Avigilon Control Center™ server software sold by Avigilon Corporation. In another example, the analytics engine module 172 can be a software component of some other commercially available Video Management Software (VMS) that provides similar video analytics functionality. The analytics engine module 172 can, in some examples, use the descriptive characteristics of the person's or object's appearance. Examples of these characteristics include the person's or object's shape, size, textures and color.

Still with reference to FIG. 1, the server system 108 also includes a credentials manager 175. The credentials manager 175 controls user authentication and permission settings within the surveillance system 100. In some examples, the credentials manager 175 recognizes certain users of the VMS as having higher credentials than other users of the VMS and controls the respective access rights within the VMS accordingly. In still other examples, the credentials manager 175 allows different recognized objects (people) to have different abilities to make gestures to permit redaction as explained subsequently herein in more detail.

The server system 108 also includes a number of other software components 176. These other software components will vary depending on the requirements of the server system 108 within the overall system. As just one example, the other software components 176 might include special test and debugging software, or software to facilitate version updating of modules within the server system 108. The server system 108 also includes one or more data stores 190. In some examples, the data store 190 comprises one or more databases 191 which facilitate the organized storing of recorded surveillance video, including surveillance video to be exported in redacted and/or otherwise modified form in accordance with example embodiments.

Regarding the video cameras 169, each of these includes a camera module 198. In some examples, the camera module 198 includes one or more specialized integrated circuit chips to facilitate processing and encoding of surveillance video before it is even received by the server system 108. For instance, the specialized integrated circuit chip may be a System-on-Chip (SoC) solution including both an encoder and a Central Processing Unit (CPU). These permit the camera module 198 to carry out the processing and encoding functions. Also, in some examples, part of the processing functions of the camera module 198 includes creating metadata for recorded surveillance video. For instance, metadata may be generated relating to one or more foreground areas that the camera module 198 has detected, and the metadata may define the location and reference coordinates of the foreground visual object within the image frame. For example, the location metadata may be further used to generate a bounding box, typically rectangular in shape, outlining the detected foreground visual object. The image within the bounding box may be extracted for inclusion in metadata. The extracted image may alternately be smaller then what was in the bounding box or may be larger then what was in the bounding box. The size of the image being extracted can also be close to, but outside of, the actual boundaries of a detected object.

In some examples, the camera module 198 includes a number of submodules for video analytics such as, for instance, an object detection submodule, an instantaneous object classification submodule, a temporal object classification submodule and an object tracking submodule. Regarding the object detection submodule, such a submodule can be provided for detecting objects appearing in the Field Of View (FOV) of the camera 169. The object detection submodule may employ any of various object detection methods understood by those skilled in the art such as, for example, motion detection and/or blob detection.

Regarding the object tracking submodule that may form part of the camera module 198, this may be operatively coupled to both the object detection submodule and the temporal object classification submodule. The object tracking submodule may be included for the purpose of temporally associating instances of an object detected by the object detection submodule. The object tracking submodule may also generate metadata corresponding to visual objects it tracks.

Regarding the instantaneous object classification submodule that may form part of the camera module 198, this may be operatively coupled to the object detection submodule and employed to determine a visual objects type (such as, for example, human, vehicle or animal) based upon a single instance of the object. The input to the instantaneous object classification submodule may optionally be a sub-region of an image in which the visual object of interest is located rather than the entire image frame.

Regarding the temporal object classification submodule that may form part of the camera module 198, this may be operatively coupled to the instantaneous object classification submodule and employed to maintain class information of an object over a period of time. The temporal object classification submodule may average the instantaneous class information of an object provided by the instantaneous classification submodule over a period of time during the lifetime of the object. In other words, the temporal object classification submodule may determine a type of an object based on its appearance in multiple frames. For example, gait analysis of the way a person walks can be useful to classify a person, or analysis of the legs of a person can be useful to classify a bicycler. The temporal object classification submodule may combine information regarding the trajectory of an object (e.g. whether the trajectory is smooth or chaotic, whether the object is moving or motionless) and confidence of the classifications made by the instantaneous object classification submodule averaged over multiple frames. For example, determined classification confidence values may be adjusted based on the smoothness of trajectory of the object. The temporal object classification submodule may assign an object to an unknown class until the visual object is classified by the instantaneous object classification submodule subsequent to a sufficient number of times and a predetermined number of statistics having been gathered. In classifying an object, the temporal object classification submodule may also take into account how long the object has been in the FOV. The temporal object classification submodule may make a final determination about the class of an object based on the information described above. The temporal object classification submodule may also use a hysteresis approach for changing the class of an object. More specifically, a threshold may be set for transitioning the classification of an object from unknown to a definite class, and that threshold may be larger than a threshold for the opposite transition (for example, from a human to unknown). The temporal object classification submodule may aggregate the classifications made by the instantaneous object classification submodule.

In some examples, the camera module 198 is able to detect humans and extract images of humans with respective bounding boxes outlining the human objects (for example, human full body, human face, etc.) for inclusion in metadata which along with the associated surveillance video may transmitted to the server system 108. At the system 108, the media server module 168 can process extracted images and generate signatures (e.g. feature vectors) to represent objects. In computer vision, a feature descriptor is generally known as an algorithm that takes an image and outputs feature descriptions or feature vectors. Feature descriptors encode information, i.e. an image, into a series of numbers to act as a numerical “fingerprint” that can be used to differentiate one feature from another. Ideally this information is invariant under image transformation so that the features may be found again in another image of the same object. Examples of feature descriptor algorithms are SIFT (Scale-invariant feature transform), HOG (histogram of oriented gradients), and SURF (Speeded Up Robust Features).

In accordance with at least some examples, a feature vector is an n-dimensional vector of numerical features (numbers) that represent an image of an object processable by computers. By comparing the feature vector of a first image of one object with the feature vector of a second image, a computer implementable process may determine whether the first image and the second image are images of the same object.

Similarity calculation can be just an extension of the above. Specifically, by calculating the Euclidean distance between two feature vectors of two images captured by one or more of the cameras 169, a computer implementable process can determine a similarity score to indicate how similar the two images may be.

In accordance with at least some examples, storage of feature vectors within the surveillance system 100 is contemplated. For instance, feature vectors may be indexed and stored in the database 191 with respective video. The feature vectors may also be associated with reference coordinates to where extracted images of respective objects are located in respective video. Storing may include storing surveillance video with, for example, time stamps, camera identifications, metadata with the feature vectors and reference coordinates, etc.

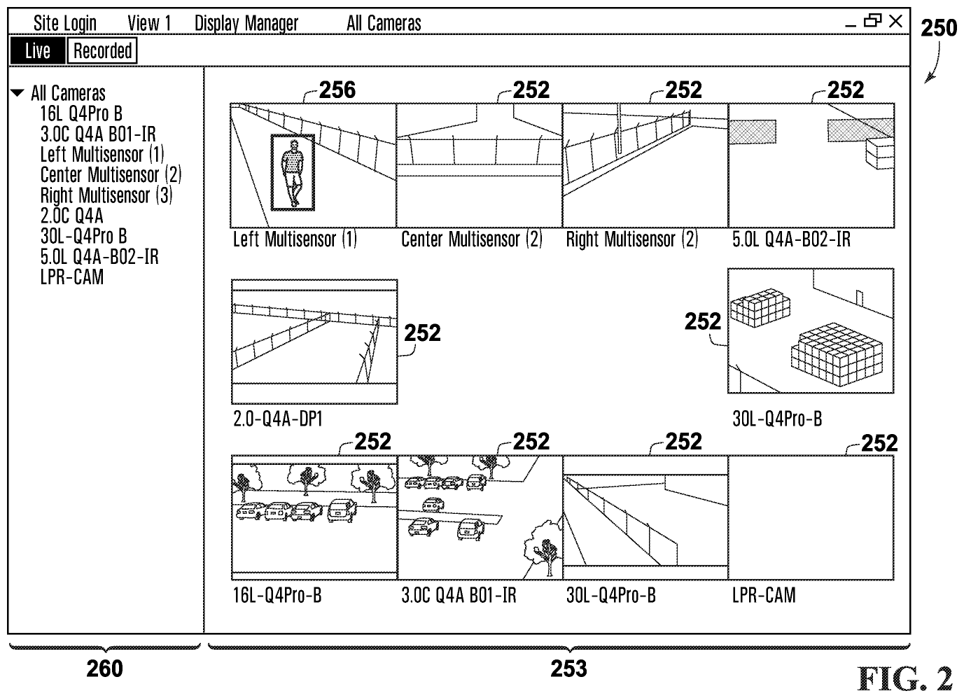

Reference will now be made to FIG. 2. FIG. 2 shows a user interface page 250, for concurrently viewing a plurality of videos, in accordance with an example embodiment implemented using the client-side video review application 144 (FIG. 1). As shown, the user interface page 250 includes a plurality of image frames 252 (all within viewing region 253) of respective videos obtained using different cameras 169 to which the user has access via the application 144. The application 144 displays the page 250 on the display 126 of the terminal 104.

In the illustrated example embodiment, at least image frame 256 corresponds to live video; however, regarding the remaining other image frames 252, these may correspond to all live video, all recorded video, or some combination of live and recorded video. It will also be noted that, in addition to the region 253, the user interface page 250 also includes a region 260, adjacent to the region 253, within which a user can expand or collapse hierarchically organized lists of the cameras 169 available to provide viewable video to the user of the application 144.

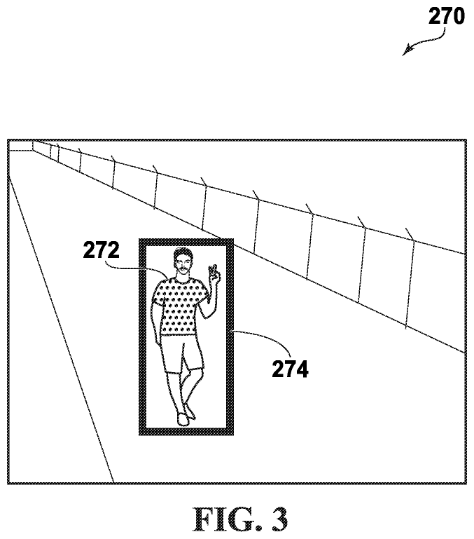

Reference will now be made to FIG. 3. FIG. 3 shows a subregion 270 of the user interface page 250 and, more specifically, the same subregion where the image frame 256 was positioned in FIG. 2. Within the illustrated image frame shown in the subregion 270, person 272 is outlined by bounding box 274. The person 272 is making a unique gesture (for example, a peace symbol with the fingers of one of his hands). As further explained below, this unique gesture can initiate a video analytics response to set in motion (or stop) redaction of the individual from live video and/or recorded video.

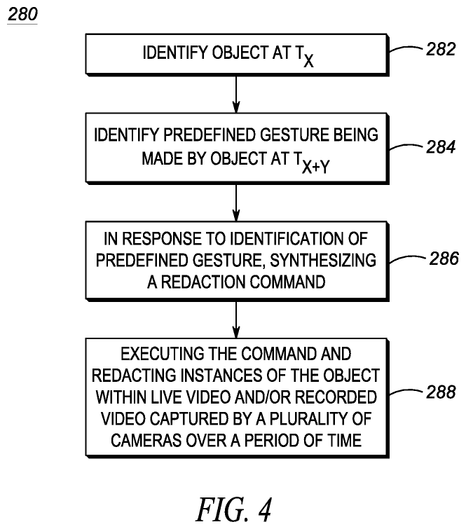

Continuing on, FIG. 4 is a flow chart illustrating a method 280 for object-initiated redaction of surveillance video in accordance with an example embodiment. Now before continuing on in the description of FIG. 4 it should be noted that, while presently an example embodiment in relation gesturing to start or otherwise carry out redaction is described, gesturing to stop or otherwise limit redaction in some manner is also contemplated and consistent with some alternative example embodiments.

First, an object is identified (282) at time tₓ. For example, the analytics engine module 172 (FIG. 1) identifies the person 272 as an object within the FOV of the camera 169 that is capturing video of the scene. As understood by those skilled in the art, this occurrence at time tₓ can be visually characterized by the appearance of the bounding box 274 around the object.

Next, a predefined gesture being made by the object is identified (284) at time t_{x+y}. For example, the analytics engine module 172 (FIG. 1) identifies that the person 272 is making a peace symbol with the fingers of one of his hands (FIG. 3) which in this illustrated example is a predefined gesture that can be identified by the analytics engine module 172 to cause a responsive action, i.e. next in response to the predefined gesture, a reaction command is synthesized (286).

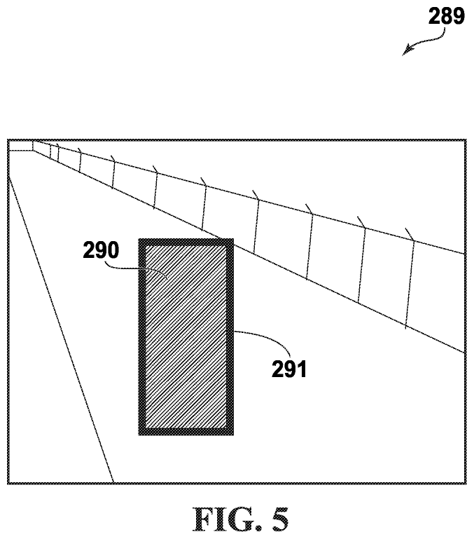

Next, the command is executed (288); this execution in turn resulting in instances of the object being redacted within live and/or recorded video having been captured by a subset (or all) of the cameras 169 (FIG. 1) over a period of time. FIG. 5 shows an example of the redaction result: a user interface page subregion 289 is depicted with the person 272 being redacted out. Specifically a rectangular area of pixel space 290 defined entirely within bounding box 291 can be entirely black, grey, or other suitable color such that the person 272 is redacted out.

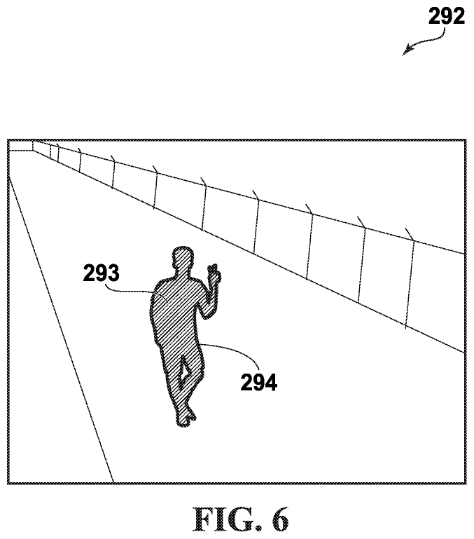

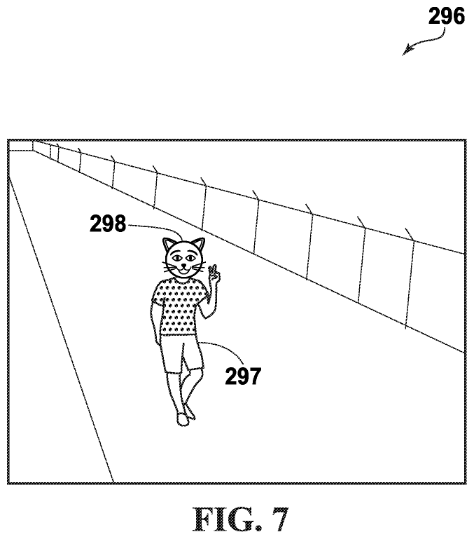

Also, it will be understood that redaction, in accordance with example embodiments, need not necessarily be rectangular area redaction, and that other forms of redaction are contemplated. FIG. 6 shows a similar subregion of a user interface page as shown in FIG. 5, but where segmentation mask redaction, instead of rectangular area redaction, has been carried out within illustrated subregion 292. Specifically, an area of pixel space 293 defined entirely within curved-lined object perimeter 294 can be entirely black, grey, or other suitable color such that the person 272 is redacted out. Likewise FIG. 7 shows a similar subregion of a user interface page as shown in FIG. 5, but where cartoon redaction, instead of rectangular area redaction, has been carried out within illustrated subregion 296. Specifically, a head region part of an area of pixel space 297 has been redacted over by a cartoon head 298. In accordance with some examples, the cartoon head may be expressionless; however in accordance with other alternative examples the analytics engine module 172 of the server system 108 (FIG. 1) can detect visible facial expressions and emotions of the partially redacted person 272 and thereby an expression on the cartoon head 298 may change over time to match the detected facial expressions and emotions. Suitable modifications of conventional methods for detecting visible facial expressions and emotions in video (such as is disclosed in Majumdar et al, “Human Face Expression Recognition”, IJETAE, July 2014) will be easily understood by those skilled art. Also, although FIG. 7 only shows the head region being redacted, it also contemplated that cartoon redaction can be carried out in relation to the whole body of the person 272.

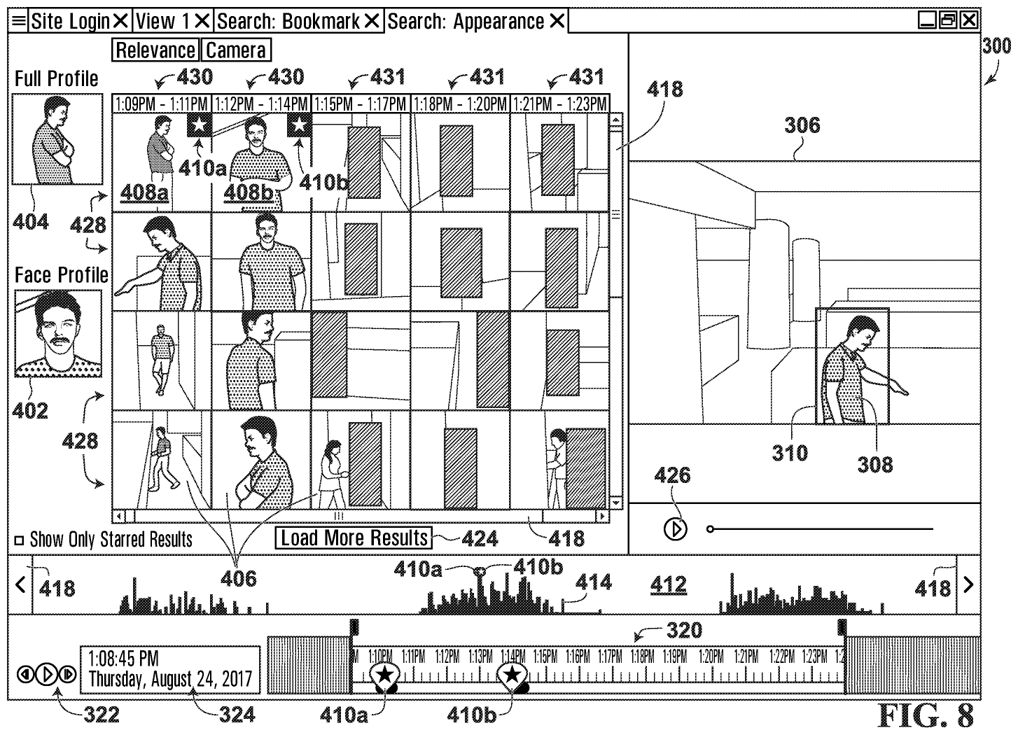

Referring now to FIG. 8, a user interface page 300 (of the application 144) is shown after the server system 108 has completed a search for a person 308 (corresponding to the person 272 of FIG. 3). The page 300 concurrently displays image frame 306 of the selected surveillance video recording the user used to commence the search bordering a right edge of the page 300; immediately to the left of the image frame 306, image search results 406 selected from the collection of surveillance video recordings by the server system 108 as potentially corresponding to the person 308 (shown in within bounding box 310 within the image frame 306); and, immediately to the left of the image search results 406 and bordering a left edge of the page 300, a face thumbnail 402 and a body thumbnail 404 of the person 308.

While surveillance video is being recorded, at least one of the cameras 169 and server system 108 identify when people, each of whom is a potential person 308, are being recorded and, for those people, attempt to identify each of their faces. The server system 108 generates signatures based on the faces (when identified) and bodies of the people who are identified, as described above. The server system 108 stores information on whether faces were identified and the signatures as metadata together with the surveillance video recordings.

In response to search commencement user input that the user of the application 144 provides, the server system 108 generates the image search results 406 by searching the collection of surveillance video recordings for the person 308. The server system 108 of the illustrated example embodiment performs a combined search that includes a body search and a face search on the collection of surveillance video recordings using the metadata recorded for the person's 308 body and face, respectively. More specifically, the server system 108 compares the body and face signatures of the person 308 that the user indicates he or she wishes to perform a search on, to the body and face signatures, respectively, for other people that the system 108 has identified. The server system 108 returns the search results 406, which includes a combination of the results of the body and face searches, which the application 144 uses to generate the page 300. Any suitable method may be used to perform the body and face searches; for example, the server system 108 may use a Convolutional Neural Network (CNN) when performing the body search.

In one example embodiment, the face search is done by searching the collection of surveillance video recordings for faces. Once a face is identified, the coordinates of a bounding box (noting, as eluded to before, that there is no requirement in video analytics that bounding boxes be restricted in their function to just outlining a full human body) that bounds the face (e.g., in terms of an (x,y) coordinate identifying one corner of the box, and width and height of the box) and an estimation of the head pose (e.g., in terms of yaw, pitch, and roll) are generated. A feature vector may be generated that characterizes those faces using any one or more metrics. For example, for each face, any one or more of distance between the corners of eyes, distance between the centers of eyes, nose width, depth of eye sockets, shape of cheekbones, shape of jaw line, shape of chin, hair color, and the presence and color of facial hair may be used as metrics. Once the feature vectors are generated for the faces, the Euclidean distance between vectors for different faces may be determined and used to assess face similarity.

In at least one example embodiment, the cameras 169 generate the metadata and associated feature vectors in or nearly in real-time, and the server system 108 subsequently assesses face similarity using those feature vectors. However, in at least one alternative example embodiment the functionality performed by the cameras 169 and server system 108 may be different. For example, functionality may be divided between the server system 108 and cameras 169 in a manner different than as described above. Alternatively, one of the server system 108 and the cameras 169 may generate the feature vectors and assess face similarity.

In FIG. 8, the image search results 406 comprise multiple images arranged in an array comprising n rows 428 (with n=1 corresponding to the array's topmost row 428) and m columns (first two columns labelled 430, last three columns labelled 431, and m=1 corresponding to the array's leftmost column 430). The results 406 are positioned in a window along the right and bottom edges of which extend scroll bars 418 that permit the user to scroll through the array. In FIG. 8, the array comprises at least 4×5 images, as that is the portion of the array that is visible without any scrolling using the scroll bars 418.

Each of the columns 430 of the image search results 406 corresponds to a different time period of the collection of surveillance video recordings. In the example of FIG. 8, each of the columns 430 corresponds to a three minute duration, with the leftmost column 430 representing search results 406 from 1:09 p.m. to 1:11 p.m., inclusively, the rightmost column 430 representing search results 406 from 1:21 p.m. to 1:23 p.m., inclusively, and the middle three columns 430 representing search results 406 from 1:12 p.m. to 1:20 p.m., inclusively.

In the depicted embodiment, all of the search results 406 satisfy a minimum likelihood that they correspond to the person 308; for example, in certain embodiments the application 144 only displays search results 406 that have at least a 25% likelihood (“match likelihood threshold”) of corresponding to the person 308. However, in certain other embodiments, the application 144 may use a non-zero match likelihood threshold that is other than 25%, or may display search results 406 in a manner not specifically based on a match likelihood threshold.

In FIG. 8, the body and face thumbnails 404,402 include at least a portion of a first image 408a and a second image 408b, respectively, which include part of the image search results 406. The first and second images 408a,b, and accordingly the body and face thumbnails 404,402, are different in FIG. 8; however, in different embodiments (not depicted), the thumbnails 404,402 may be based on the same image. Overlaid on the first and second images 408a,b are a first and a second indicator 410a,b, respectively, indicating that the first and second images are the bases for the body and face thumbnails 404,402. In FIG. 8 the first and second indicators 410a,b are identical stars, although in different embodiments (not depicted) the indicators 410a,b may be different.

Located immediately below the image frame 306 of the selected surveillance video recording are play/pause controls 426 that allow the user to play and pause the selected surveillance video recording. Located immediately below the horizontal scroll bar 418 beneath the image search results 406 is a load more results button 424, which permits the user to prompt the application 144 for additional tranches of search results 406. For example, in one embodiment, the application 144 may initially deliver at most a certain number of results 406 even if additional results 406 exceed the match likelihood threshold. In that example, the user may request another tranche of results 406 that exceed the match likelihood threshold by selecting the load more results button 424. In certain other embodiments, the application 144 may be configured to display additional results 406 in response to the user's selecting the button 424 even if those additional results 406 are below the match likelihood threshold.

Spanning the width of the page 300 and located below the thumbnails 402,404, search results 406, and image frame 306 is an appearance likelihood plot for the person 308 in the form of a bar graph 412. The bar graph 412 depicts the likelihood that the person 308 appears in the collection of surveillance video recordings over a given time span. In FIG. 8, the time span is divided into time periods of one day, and the entire time span is approximately three days (from August 23-25, inclusive). Each of the time periods is further divided into discrete time intervals, each of which is represented by one bar 414 of the bar graph 412. The bar graph 412 is bookmarked at its ends by bar graph scroll controls 418, which allow the user to scroll forward and backward in time along the bar graph 412.

To determine the bar graph 412, the server system 108 determines, for each of the time intervals, a likelihood that the person 308 appears in the collection of surveillance video recordings for the time interval, and then represents that likelihood as the height of the bar 414 for that time interval. In this example embodiment, the server system 108 determines that likelihood as a maximum likelihood that the person 308 appears in any one of the collection of surveillance video recordings for that time interval. In different embodiments, that likelihood may be determined differently. For example, in one different embodiment the server system 108 determines that likelihood as an average likelihood that the person 308 appears in the image search results 406 that satisfy the match likelihood threshold.

The page 300 of FIG. 8 also includes the timeline 320, video control buttons 322, and video time indicator 324 extending along the bottom of the page 300.

The application 144 permits the user to provide match confirmation user input regarding whether at least one of the image search results 406 depicts the person 308. The user may provide the match confirmation user input by, for example, selecting one of the image search results 406 to bring up a context menu (not shown) allowing the user to confirm whether that search result 406 depicts the person 308. In response to the match confirmation user input, the server system 108 in the depicted embodiment determines whether any match likelihoods change and, accordingly, whether positioning of the image search results 406 is to be changed in response to the match confirmation user input. For example, in one embodiment when the user confirms one of the results 406 is a match, the server system 108 may use that confirmed image as a reference for comparisons when performing one or both of face and body searches. When the positioning of the image search results is to be changed, the application 144 updates the positioning of the image search results 406 in response to the match confirmation user input. For example, the application 144 may delete from the image search results 406 any result the user indicates does not contain the person 308 and rearrange the remaining results 406 accordingly.

When the match confirmation user input indicates that any one of the selected image results 406 depicts the person 308, the application 144 displays indicators (for example, stars in the corners of the respective thumbnails) for the selected image results 406 that the user confirms corresponds to the person 308.

Another further point to note regarding FIG. 8 is the difference between the search results shown in the columns 430 and the search results shown in the columns 431. In the columns 430, the person 308 is fully revealed. By contrast, the person is redacted in the columns 431. This selective redaction for the illustrated example embodiment could be a result of either primarily a specific gesture of the person 308, or alternatively one or more specific settings put in place by the user of the application 144. In the former case, the specific gesture of the person 308 that occurred (most likely around 1:15 PM) was distinguishable by the video analytics to effect redaction only from the point in time of the gesture going forward (as opposed to both backwards in time appearance instances and forwards in time instances). In terms of the latter case (i.e. specific settings applied by the user of the application 144) this could relate to, for example, some less dynamic type of setting in the VMS that specifies, across the board, that all objects may only be redacted from the point in time of the gesture going forwards. Examples for the contrary scenario are also contemplated (i.e. where specific gestures or specific settings effect redaction over all instances in time, such that the person 308 would be redacted in all of the search results 406). Furthermore, combinations of the above are also contemplated. For example, if the person 308 has a high enough credentials level as maintained by the credentials manager 175 (FIG. 1), then the person 308 may be permitted to redact both forwards and backwards in time (whereas other people with lower or no credentials might only be permitted to make less restrictive redaction gestures such as, for example, future-in-time redaction only, and perhaps only on certain cameras and/or for limited time durations).

Certain adaptations and modifications of the described embodiments can be made. For example, with respect to the client-side video review application 144 (FIGS. 1 and 2), this has been herein described as software installed on the client terminal 104 (e.g. packaged software); however in some alternative example embodiments implementation of the UI can be achieved with less installed software through the use of a web browser application (e.g. one of the other applications 152 shown in FIG. 1). A web browser application is a program used to view, download, upload, surf, and/or otherwise access documents (for example, web pages). In some examples, the browser application may be the well-known Microsoft® Internet Explorer®. Of course other types of browser applications are also equally possible including, for example, Google® Chrome™. The browser application reads pages that are marked up (for example, in HTML). Also, the browser application interprets the marked up pages into what the user sees rendered as a web page. The browser application could be run on the computer terminal 104 to cooperate with software components on the server system 108 in order to enable a computer terminal user to carry out actions related to providing input in order to, for example, facilitate identifying same individuals or objects appearing in a plurality of different surveillance video recordings. In such circumstances, the user of the computer terminal 104 is provided with an alternative example user interface through which the user inputs and receives information in relation to the surveillance video recordings.

Therefore, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method comprising:
using video analytics to detect and recognize a predefined gesture being made by an object appearing in analyzable video; and
in response to a determination that the predefined gesture has been made, redacting a plurality of appearance instances of the object present within first video captured by a first video camera and second video captured by a second camera.

2. The method of claim 1 further comprising:
prior to the detecting and recognizing of the predefined gesture, displaying a bounding box with edges, wherein the bounding box maintains a dynamically changing rectangular shape that follows the object so that a majority portion of the object remains contained within the edges of the bounding box, and
wherein the analyzable video is the first video, and the redacting includes obscuring the majority portion of the object corresponding to inside of the bounding box.

3. The method of claim 2 wherein the predefined gesture is a gesture made by at least one hand of the object.

4. The method of claim 2 wherein the first, video is entirely recorded video and the second video is also entirely recorded video.

5. The method of claim 2 wherein the redacting of the object within the first video includes redacting live video.

6. The method of claim 5 wherein the redacting of the object within the second video is carried out without redacting any live video of the second camera.

7. The method of claim 1 wherein the predefined gesture is a gesture made by at least one hand of the object.

8. The method of claim 1 wherein the first, video is entirely recorded video and the second video is also entirely recorded video.

9. The method of claim 1 wherein the redacting of the object within the first video includes redacting live video.

10. The method of claim 9 wherein the redacting of the object within the second video is carried out without redacting any live video of the second camera.

11. Apparatus comprising:
at least one physical machine configured to:
use video analytics to detect and recognize a predefined gesture being made by an object appearing in analyzable video; and
in response to a determination that the predefined gesture has been made, redact a plurality of appearance instances of the object present within first video captured by a first video camera and second video captured by a second video camera.

12. The apparatus of claim 11 wherein the at least one physical machine is further configured to redact both live video and recorded video.

13. At least one tangible, non-transitory, computer-readable storage medium having instructions encoded therein, wherein the instructions, when executed by at least one processor, causes a carrying out of a method comprising:
using video analytics to detect and recognize a predefined gesture being made by an object appearing in analyzable video; and
in response to a determination that the predefined gesture has been made, redacting a plurality of appearance instances of the object present within first video captured by a first video camera and second video captured by a second camera.

14. The computer-readable storage medium of claim 13, wherein the method further comprises:
prior to the detecting and recognizing of the predefined gesture, displaying a bounding box with edges, wherein the bounding box maintains a dynamically changing rectangular shape that follows the object so that a majority portion of the object remains contained within the edges of the bounding box, and
wherein the analyzable video is the first video, and the redacting includes obscuring the majority portion of the object corresponding to inside of the bounding box.

15. (canceled)

16. (canceled)

17. (canceled)

18. (canceled)

19. (canceled)

20. (canceled)

21. The method of claim 1 wherein the redacting of the plurality of the appearance instances of the object is redacting future-in-time only appearance instances of the object.

22. The method of claim 1 further comprising employing a credentials manager to recognize the object and credentials associated therewith.

23. The apparatus of claim 11 further comprising a plurality of video cameras that include the first and second video cameras, and the video cameras in communication with the physical machine.

24. The apparatus of claim 11 wherein the physical machine includes a credentials manager configured to recognize the object and credentials associated therewith.

25. The computer-readable storage medium of claim 13 wherein the redacting of the plurality of the appearance instances of the object is redacting future-in-time only appearance instances of the object.

26. The computer-readable storage medium of claim 13 wherein the method further comprising employing a credentials manager to recognize the object and credentials associated therewith.
